(19) United States
(12) Patent Application Publication
(10) Pub. No.: US 2025/0238350 A1
(43) Pub. Date: Jul. 24, 2025

(54) METHOD AND SYSTEM FOR CREATING SYNTHESIZED TEST DATA HAVING PREDEFINED TEST CASE COVERAGE

(71) Applicant: SYNTHESIZED LTD, London (GB)

(72) Inventor: Nikolay Baldin, London (GB)

(21) Appl. No.: 18/418,610

(22) Filed: Jan. 22, 2024

(51) Int. Cl. G06F 11/36

(52) U.S. Cl. CPC G06F 11/3676; G06F 11/3684; G06F 11/3688

(57) ABSTRACT

Disclosed is method for creating synthesized test data (302) having predefined test case coverage, method comprising processing query for extracting plurality of test cases (PTC) and for determining data storage location of input test data (ITD) corresponding to PTC; extracting ITD from data repository (204, 310) and executing PTC on ITD for determining individual test case coverage percentages of ITD; determining overall test case coverage (OTCC) (308) of ITD; when OTCC of ITD is less than predefined test case coverage, identifying one or more test cases (312) for which individual test case coverage percentage of ITD is less than predefined value; analyzing distribution of ITD; and rebalancing ITD based on distribution of ITD, for producing synthesized test data, wherein ITD is rebalanced for covering conditions in one or more test cases in manner that OTCC of synthesized test data would be equal to or greater than predefined test case coverage.

### TECHNICAL FIELD

The present disclosure relates to methods for creating synthesized test data having predefined test case coverages. Moreover, the present disclosure relates to systems for creating synthesized test data having predefined test case coverages.

### BACKGROUND

Conventionally, before launching any new software application, that software application is made to undergo a testing phase for detecting bugs and other problems within the software application. In the testing phase, a number of test cases are executed on the software application to test an operation of the software application under various different real-life scenarios.

However, the present solutions for the testing of the software application require the test cases to be manually created. As a result, the test cases are not created for every possible real-life scenario in which the software application may operate and subsequently, the testing of the software application cannot be done to a complete extent. Moreover, in some present solutions, data values are not available to execute even those test cases that are already created for the testing of the software application. Furthermore, the present solutions rely on use of those data values for executing the test cases, that either contains sensitive information or are different from real day-to-day operational data, which reduces a quality of results obtained from executing the test cases on the software application.

Therefore, in light of the foregoing discussion, there exists a need to overcome the aforementioned drawbacks.

### SUMMARY

The aim of the present disclosure is to provide a method and a system to remove insufficiency in test case coverage. The aim of the present disclosure is achieved by a method and a system for creating a synthesized test data having a predefined test case coverage as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a flowchart depicting steps of a method for creating a synthesized test data having a predefined test case coverage, in accordance with an embodiment of the present disclosure;

FIG. 2 is a block diagram of a system for creating a synthesized test data having a predefined test case coverage, in accordance with an embodiment of the present disclosure;

FIG. 3 is a schematic illustration of an environment of an implementation scenario system for creating a synthesized test data having a predefined test case coverage, in accordance with an embodiment of the present disclosure;

FIGS. 4A and 4B are schematic illustrations of different views of a user interface depicting a test case coverage report, in accordance with an embodiment of the present disclosure; and

FIG. 5 is a schematic illustration of a user interface depicting how rebalancing an input test data is performed, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for creating a synthesized test data having a predefined test case coverage, the method comprising:
processing a query for extracting a plurality of test cases and for determining a data storage location of input test data corresponding to the plurality of test cases;
extracting the input test data from a data repository and executing the plurality of test cases on the input test data for determining individual test case coverage percentages of the input test data;
determining an overall test case coverage of the input test data, based on the individual test case coverage percentages of the input test data;
when the overall test case coverage of the input test data is less than the predefined test case coverage, identifying one or more test cases amongst the plurality of test cases for which individual test case coverage percentage of the input test data is less than a predefined value;
analyzing a distribution of the input test data, with respect to conditions in the one or more test cases; and
rebalancing the input test data based on the distribution of the input test data, for producing the synthesized test data, wherein the input test data is rebalanced for covering the conditions in the one or more test cases in a manner that an overall test case coverage of the synthesized test data would be equal to or greater than the predefined test case coverage.

The present disclosure provides an aforementioned method. The method is able to significantly improve the overall test case coverage to ensure that all possible real-life scenarios that require testing are included in the plurality of test cases. Moreover, producing the synthesized test data increases an availability of data values for providing optimal coverage for all conditions in the plurality of test cases. Furthermore, the synthesized test data is of higher data quality, higher testing coverage, lower risk of privacy leakage, higher scalability in comparison to the input test data.

In a second aspect, the present disclosure provides a system for creating a synthesized test data having a predefined test case coverage, the system comprising at least one processor configured to:
process a query for extracting a plurality of test cases and for determining a data storage location of input test data corresponding to the plurality of test cases;
extract the input test data from a data repository and execute the plurality of test cases on an input test data and determining individual test case coverage percentages of the input test data;
determine an overall test case coverage of the input test data, based on the individual test case coverage percentages of the input test data;
when the overall test case coverage of the input test data is less than the predefined test case coverage, identify one or more test cases amongst the plurality of test cases for which individual test case coverage percentage of the input test data is less than a predefined value;
analyze a distribution of the input test data, with respect to conditions in the one or more test cases; and
rebalance the input test data based on the distribution of the input test data, for producing the synthesized test data, wherein the input test data is rebalanced to cover the conditions in the one or more test cases in a manner that an overall test case coverage of the synthesized test data would be equal to or greater than the predefined test case coverage.

The present disclosure provides an aforementioned system. The system is able to significantly improve the overall test case coverage to ensure that all possible real-life scenarios that require testing are included in the plurality of test cases. Moreover, the synthesized test data increases an availability of data values for execution of optimal number of conditions in the plurality of test cases. Furthermore, the synthesized test data is of higher data quality, higher testing coverage, lower risk of privacy leakage, higher scalability in comparison to the input test data.

Throughout the present disclosure, the term “synthesized test data” refers to that test data which is produced by rebalancing the input test data. It will be appreciated that the synthesized test data is produced to ensure that test cases for all required scenarios are covered under the overall test case coverage of the synthesized test data. Throughout the present disclosure, the term “predefined test case coverage” refers to a threshold value that enables to check whether the overall test case coverage of the synthesized test data is at a required level or not. Notably, if the overall coverage of the synthesized test data is equal to or greater than the predefined test case coverage, then the test cases for all the required scenarios are covered in the overall test case coverage of the synthesized test data. Likewise, if the overall coverage of the synthesized test data is less than the predefined test case coverage, then the test cases for all the required scenarios are not covered in the overall test case coverage of the synthesized test data. Optionally, the predefined test case coverage is in form of a percentage. For example, the predefined test case coverage is 70 percent.

Throughout the present disclosure, the term “query” refers to an information in form a statement that is indicative of the plurality of test cases that are to be executed. Optionally, the query is parsed into a structured format that enables to easily process the query. Optionally, the query comprises a plurality of sub-queries, wherein each of the sub-queries are processed individually for extracting the plurality of test cases. Throughout the present disclosure, the term “plurality of test cases” refers to simulations of a given application that replicates corresponding real-life scenarios to validate and check performance of the given application under those corresponding real-life scenarios. Notably, the plurality of test cases are extracted from the query by processing the information indicated in the query related to the plurality of test cases.

Optionally, the method further comprises at least one of:
creating the plurality of test cases; and
accessing a record of pre-created test cases that is stored at the data repository.

In this regard, creating the plurality of test cases relates to creating the individual test cases for all possible real-life scenarios that might arise with respect to an operation of the given application for which the plurality of test cases are being created. Throughout the present disclosure, the term “pre-created test cases” refers to previously created test cases for testing of previous applications. The record of the pre-created test cases stored in the data repository is accessed to determined if any of the pre-created test cases are suitable for testing of the given application, and subsequently, those pre-created test cases that are suitable for the testing of the given application are included in the plurality of test cases. A technical effect is that the plurality of test cases comprises the individual test cases for as many real-life scenarios related to the operation of the given application as possible.

Throughout the present disclosure, the term “input test data” refers to that test data which is used to execute the plurality of test cases. It will be appreciated that the input test data provides numerical values that are representative of the corresponding real-life scenarios and are subsequently, used to execute the plurality of test cases. Optionally, the input test data has same schema, data type and statistical properties as a production data and is one of: an obfuscated subset of the production data, mock data. In this regard, the term “production data” refers to real-life data that is generated from day-to-day operations of any application. Notably, the production data contains sensitive information as the production data reflects an actual state of performance of that application. It will be appreciated that use of the production data as the input test data ensures that the data values used for the execution of the plurality of test cases are as close as possible to the real-life data, and thus, enables to achieve good quality results from the execution of the plurality of test cases. Throughout the present disclosure, the term “schema” refers to a structure of any data that defines how information in the production data is organized, categorized, and stored. Notably, the schema of the production data specifies tables, columns, relationships, constraints and the like of the information stored in the production data. It will be appreciated that the input test data having same schema as that of the production data implies that the structure of the input test data is similar to structure of the production data. Throughout the present disclosure, the term “data type” refers to a format which specifies what type of values are stored in any data. It will be appreciated that the input test data having the same data type as that of the production data implies that the type of values stored in the input test data is similar to the types of values stored in the production data. Throughout the present disclosure, the term “statistical properties” refers to quantitative characteristics that describe a distribution, a behaviour, and patterns within any data. It will be appreciated that the input test data having the same statistical properties as that of the production data implies that the distribution, the behaviour and the patterns within the input test data is same as that of the production data. Notably, the input test data being the production data and the input test data having the same schema, the data type and the statistical properties as the production data enables to execute the plurality of test cases using the real-world information present in the production data for getting results that are effective in ensuring smooth functioning of the application in real-world, for which the plurality of test cases are executed. Throughout the present disclosure, the term “obfuscated subset of the production data” refers to a modified or transformed version of a portion of the production data. Notably, the obfuscated subset of the production data is obtained to remove any sensitive information that is present in the production data, while retaining essential characteristics and structure of the production data. It will be appreciated that the input test data being the obfuscated subset of the production data enables to execute the plurality of test cases using that data which does not contain any sensitive information while having the same characteristics and structure as that of the real-world information present in the production data. Throughout the present disclosure, the term “mock data” refers to artificially generated data that resembles the real-world information of the production data without containing any actual real-world information. It will be appreciated that the input test data being the mock data enables to execute the plurality of test cases using that data which resembles the same characteristics and structure as that of the real-world information present in the production data without using any real-world information of the production data. A technical effect of the input test data being one of: the production data, the obfuscated subset of the production data, the mock data is that high-quality, easily available and large quantities of data is obtained as the input test data.

Optionally, the method further comprising removing sensitive data from the input test data. In this regard, the term “sensitive data” refers to those data values in the input test data that contains personal details or information of users gathered from day-to-day operations of other applications. Notably, the presence of the sensitive data in the input test data may result in use of the sensitive data for the execution of the plurality of test cases which leads to a breach of privacy, and may hinder the day-to-day operations and a production environment. Thus, the sensitive data is removed from the input test data by removing those data values belonging to the sensitive data from the input test data. A technical effect of removing the sensitive data from the input test data prevents any breach of privacy in using the input test data for the execution of the plurality of test cases. Throughout the present disclosure, the term “storage location of the input test data” refers to a location in the data repository where the input test data is stored. Optionally, the input test data may be a part of a large database stored in the data repository, and determining the data storage location of the input test data enables to determine which part of the large database corresponds to the input test data. Optionally, the storage location of the input test data may be provided in the query in form of pointers to specific columns in the database from which the input test data is to be extracted. Throughout the present disclosure, the term “data repository” refers to hardware, software, firmware, or a combination of these for storing the input test data, in an organized (namely, structured) manner, thereby, allowing for easy storage, and extraction (namely, retrieval) of the input test data. Subsequently, determining the data storage location of the input test data enables the extraction of the input test data from the data repository.

It will be appreciated that the plurality of test cases comprises individual test cases. Notably, each of an individual test case is created for a corresponding real-life scenario, wherein each individual test case comprises corresponding conditions for one or more variations that may occur in the corresponding real-life scenario for which that individual test case is created. For example, the plurality of test cases comprises 3 individual test cases, where a first individual test case comprises of 3 conditions, a second individual test case comprises of 5 conditions, and a third individual test case comprises of 6 conditions. It will be appreciated that for executing the plurality of test cases, each individual test case is executed by executing each of the corresponding conditions of each individual test case. Notably, each of the conditions of a given individual test case from amongst the plurality of test cases is executed using those data values from the input test data which are allotted for the execution of the conditions of the given individual test case. Throughout the present disclosure, the term “individual test case coverage percentages” refers to the percentages that indicate what is the coverage of each individual test case. Notably, the individual test case coverage percentages are determined based on for how many of the conditions of each individual test case, the allocated data values are present in the input test data for executing the conditions. For example, for the first individual test case comprising 3 conditions, the allocated data values in the input test data is present for 2 of the 3 conditions; for the second individual test case comprising 5 conditions, the allocated data values in the input test data is present for 4 of the 5 conditions; and for the third individual test case comprising 6 conditions, the allocated data values in the input test data is present for 4 of the 6 conditions, then the individual test case coverage percentages are determined to 67 percent, 80 percent and 67 percent respectively.

Throughout the present disclosure, the term “individual test case percentage” refers to a percentage that indicates for how many of the conditions of a given individual test case, the allocated data values are present in the input test data. Throughout the present disclosure, the term “overall test case coverage of the input test data” refers to an overall value that is indicative of all the individual test case coverages of the input test data as a whole. In other words, the overall test case coverage of the input test data is indicative of the coverage provided by the data values in the input test data for the execution of the conditions in the plurality of test cases, based on the individual test case coverage percentages. Notably, a higher value of the overall test case coverage of the input test data indicates that the data values are present in the input test data for the execution of a higher number of the individual test cases from amongst the plurality of test cases. Likewise, a lower value of the overall test case coverage indicates that the data values are present in the input test data for the execution of a lower number of the individual test cases from amongst the plurality of test cases. Optionally, the overall test case coverage is determined as an average of the individual test case coverage percentages. Alternatively, the overall test case coverage is determined as a sum total of the individual test case coverage percentages.

Notably, the overall test case coverage of the input test data being less than the predefined test case coverage indicates that the data values are not present in the input test data for the execution of a high number of conditions of the individual test cases from amongst the plurality of test cases. Throughout the present disclosure, the term “predefined value” refers to a threshold value that enables to determine for which individual test case, the individual test case percentage is lower than a threshold level. Notably, the given individual test case that has the individual test case coverage percentage less than the predefine level significantly contributes in reducing the overall test case coverage. Subsequently, identifying the one or more test cases from amongst the plurality of test cases for which the individual test case coverage percentage is less than predefined threshold level enables to identify those one or more test cases from amongst the plurality of test cases that significantly contribute in reducing the overall test case coverage.

Optionally, the predefined test case coverage lies in a range of 80 percent to 99.9 percent, and wherein the predefined value lies in a range of 60 percent to 99.9 percent. In this regard, the predefined test case coverage being in the range of 80 percent to 99.9 percent implies that the value of the predefined test case coverage is significantly high in all scenarios to ensure that the overall test case coverage is effectively compared against a significantly high threshold for effectively determining that for how many of the conditions of the individual test cases from amongst the plurality of test cases, the data values are not present in the input test data for the execution thereof. For example, the predefined test case coverage is 85 percent. Notably, the predefined value being in the range of 60 percent to 99.9 percent implies that the predefined value may be lower than the predefined test case coverage which enables to compare the individual test case coverage percentages with a lower value of threshold and subsequently, determine the one or more test cases that significantly contribute in the overall test case coverage being less than the predefined test case coverage. For example, the predefined value is 65 percent, and when the overall test case coverage is less than the predefined test case coverage value of 80 percent, then the one or more test cases from amongst the plurality of test cases for which the individual test case coverage percentage is less than 65 percent are identified.

Throughout the present disclosure, the term “conditions in the one or more test cases” refers to those conditions that define the variations in the corresponding one or more real-life scenarios for which the one or more test cases are designed. Throughout the present disclosure, the term “distribution of the input test data” refers to information that indicates what number of the data values from the input test data are allocated for execution of a given condition. Notably, the distribution of the input test data with respect to the conditions in the one or more test cases indicates what number of the data values from the input test data are allocated for execution of which condition from amongst the conditions in the one or more test cases. Subsequently, the distribution of the input test data, with respect to the conditions in the one or more test cases is analyzed by determining for which conditions in the one or more test cases, a higher number of the data values are present in the input test data for the execution thereof; for which conditions in the one or more test cases, a lower number of the data values are present in the input test data for the execution thereof; and for which conditions in the one or more test cases, no data values are present in the input test data for the execution thereof.

Throughout the present disclosure, the term “rebalancing the input test data” refers to making changes to the input test data that produces the synthesized test data for improving the coverage of the conditions in the one or more test cases by ensuring that a sufficient number of the data values are present in the synthesized test data for executing the conditions in the one or more test cases. Subsequently, the improved coverage of the conditions in the one or more test cases causes the overall test case coverage to be equal to or greater than the predefined test case coverage.

Optionally, the step of rebalancing the input test data comprises at least one of:
altering a portion of the input test data;
adding new test data to the input test data;
adjusting the distribution of the input test data across different conditions in the plurality of test cases;
validating the input test data; and
removing redundancy in the input test data.

In this regard, the term “portion of the input test data” refers to a group of data values from amongst the input test data. Notably, altering the portion of the input test data relates to making changes in the data values of the portion of the input test data in a manner that makes the data values in the altered portion suitable for execution of those conditions in the one or more test cases for which no data values or a low number of data values were present in the input test data for the execution thereof. In this regard, adding new test data to the input test data relates to adding new data values in the input test data for those conditions in the one or more test cases for which no data values or a low number of data values were present in the input test data for the execution thereof, and thus, improving the overall test case coverage. In this regard, adjusting the distribution of the input test data across different conditions in the plurality of test cases relates to shifting a given group of data values that are allocated in the input test data for the execution of those conditions in the plurality of test cases for which a high number of data values are already allocated in the input test data for the execution thereof, and subsequently, the given group of data values is then allocated for the execution of those conditions in the one or more test cases for which no data values or the low number of data values were allocated in the input test data. For example, if a first condition in the plurality of test cases has 60 data values allocated in the input test data, a second condition in the one or more test cases has 5 data values allocated in the input test data, and a third condition in the one or more test cases has no value allocated in the input test data for the execution thereof, respectively, then the distribution of the input test data is adjusted in a way that 30 data values out of the 60 data values allocated for the execution of the first condition are distributed between the second condition and the third condition by allocating 10 data values out of the 30 data values to the second condition and remaining 20 data values out of the 30 data values to the third condition. In this regard, validating the input test data relates to checking if the data values that are allocated in the input test data for the execution of the different conditions in the plurality of test cases are suitable for the execution of those different conditions in the plurality of test cases or not. In this regard, removing redundancy in the input test data relates to removing those data values from the input test data that are repetition of other data values in the input test data.

Throughout the present disclosure, the term “overall test case coverage of the synthesized test data” refers to information that is indicative of the coverage provided by the data values in the synthesized test data for the execution of the conditions in the plurality of test cases. In other words, the overall test case coverage of the synthesized test data indicates that for how many conditions in the plurality of test cases, the data values are present in the synthesized test data to be allocated for the execution of the conditions in the plurality of test cases. It will be appreciated that the synthesized test data is produced from the rebalancing of the input test data, has the data values allocated for the execution of those conditions in the one or more test cases for which no data values or low number of data values were allocated in the input test data for the execution thereof. Thus, the synthesized test data improves the coverage of the one or more test cases, and subsequently, the overall test case coverage of the synthesized test data becomes equal to or greater than the predefined test case coverage.

Optionally, the method further comprises storing the synthesized test data at the data repository. In this regard, storing the synthesized test data at the data repository enables to easily access the synthesized test data from the data repository. A technical effect of storing the synthesized test data at the data repository is that the synthesized test data is easily accessible from the data repository to be used as the input test data for another plurality of test cases for testing another application.

Optionally, the method further comprises generating a test case coverage report indicative of at least one of: the individual test case coverage percentages, the overall test case coverage, the one or more test cases, a portion of the input test data which covers a given test case, a portion of the query which indicates a given test case, a coverage status of each condition of a given test case. In this regard, the term “test case coverage report” refers to a report that enables to analyze an extent, performance and coverage of the plurality of test cases. In this regard, the term “portion of the input test case which covers a given test case” those data values in the input test data that are to be used for the execution of the conditions of the given test case from amongst the plurality of test cases. In this regard, the term “portion of the query which indicates a given test case” refers to a part of the query that is processed for the extraction of the given test case. In this regard, the term “coverage status of each condition of a given test case” refers to an indication of whether each condition of the given test case is covered by the input test data or not. Optionally, the coverage status of each condition of the given test case is in form of at least one of: a Boolean value (i.e., either True or False), a percentage value. A technical effect is that the generated test case coverage report enables to analyze an effectiveness of the synthesized test data in improving the overall test case coverage of the synthesized test case data to be equal to or greater than the predefined test case coverage.

The present disclosure also relates to the system as described above. Various embodiments and variants disclosed above, with respect to the aforementioned method, apply mutatis mutandis to the system.

Throughout the present disclosure, the term “processor” refers to a computational element that is operable to execute instructions of the system. It will be appreciated that the term “at least one processor” refers to “one processor” in some implementations, and “a plurality of processors” in other implementations. Examples of the at least one processor include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the at least one processor may refer to one or more individual servers, processing devices and various elements associated with a processing device that may be shared by other processing devices. Additionally, one or more individual processors, processing devices and elements are arranged in various architectures for responding to and processing the instructions that execute the instructions of the system.

Optionally, the system further comprises the data repository. Optionally, the data repository could be implemented as a memory of the system, a memory of a computer coupled to the system, a cloud-based memory, or similar. Optionally, the data repository is communicably coupled to the at least one processor via one of: a Wi-Fi® module, a Bluetooth® module, and the like to enable an exchange of data between the at least one processor and the data repository.

Optionally, the predefined test case coverage lies in a range of 80 percent to 99.9 percent, and wherein the second predefined value lies in a range of 60 percent to 99.9 percent.

Optionally, when rebalancing the input test data, the at least one processor is configured to perform at least one of:
alter a portion of the input test data;
add new test data to the input test data;
adjust the distribution of the input test data across different conditions in the plurality of test cases;
validate the input test data; and
remove redundancy in the input test data.

Optionally, the at least one processor is further configured to perform at least one of:
create the plurality of test cases; and
access a record of pre-created test cases that is stored at the data repository, wherein the data repository is communicably coupled to the processor.

Optionally, the at least one processor is further configured to generate a test case coverage report indicative of at least one of: the individual test case coverage percentages, the overall test case coverage, the one or more test cases, a portion of the input test data which covers a given test case, a portion of the query which indicates a given test case, a coverage status of each condition of a given test case.

Optionally, the input test data has same schema, data type and statistical properties as a production data and is one of: the production data, an obfuscated subset of the production data, mock data.

Optionally, the at least one processor is further configured to remove sensitive data from the input test data.

### DETAILED DESCRIPTION OF THE DRAWINGS

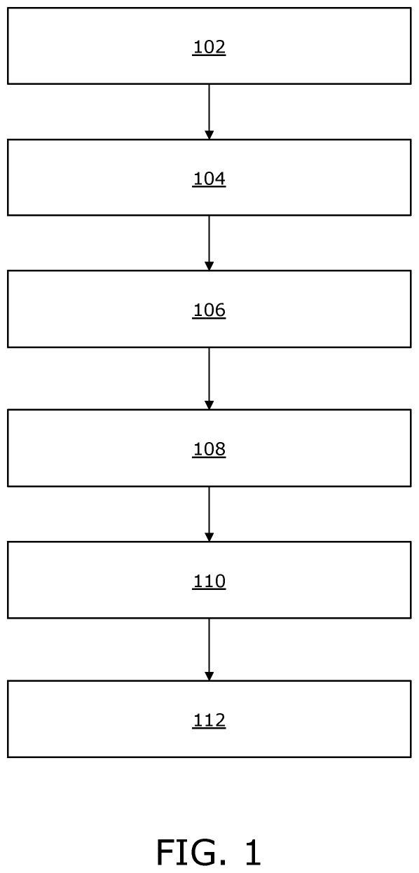

Referring to FIG. 1, illustrated is a flowchart depicting steps of a method for creating a synthesized test data having a predefined test case coverage, in accordance with an embodiment of the present disclosure. At step 102, a query is processed for extracting a plurality of test cases and for determining a data storage location of input test data corresponding to the plurality of test cases. At step 104, the input test data is extracted from a data repository and executing the plurality of test cases on the input test data for determining individual test case coverage percentages of the input test data. At step 106, an overall test case coverage of the input test data is determined, based on the individual test case coverage percentages of the input test data. At step 108, when the overall test case coverage of the input test data is less than the predefined test case coverage, one or more test cases are identified amongst the plurality of test cases for which individual test case coverage percentage of the input test data is less than a predefined value. At step 110, a distribution of the input test data is analyzed, with respect to conditions in the one or more test cases. At step 112, the input test data is rebalanced based on the distribution of the input test data, for producing the synthesized test data, wherein the input test data is rebalanced for covering the conditions in the one or more test cases in a manner that an overall test case coverage of the synthesized test data would be equal to or greater than the predefined test case coverage.

The aforementioned steps are only illustrative and other alternatives can also be provided where one or more steps are added, one or more steps are removed, or one or more steps are provided in a different sequence without departing from the scope of the claims herein.

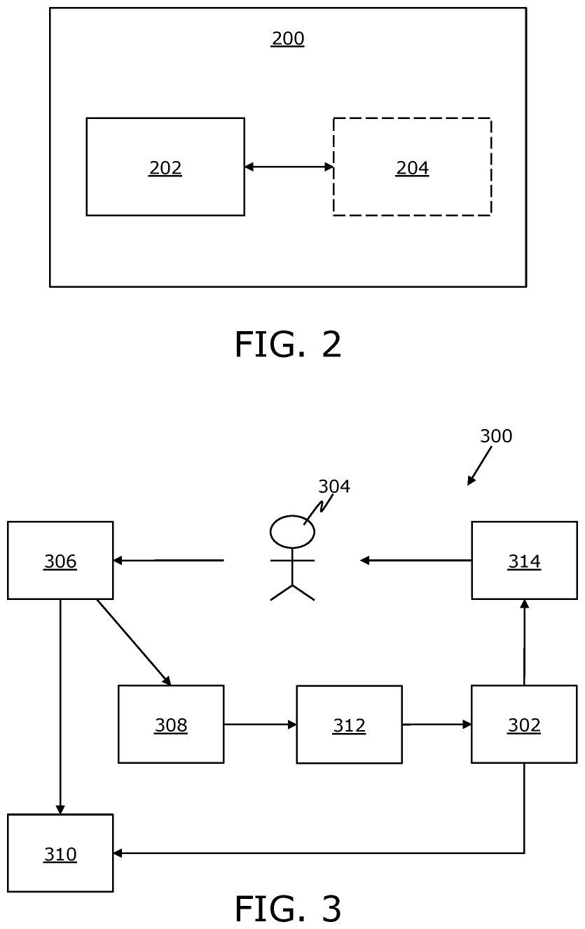

Referring to FIG. 2, illustrated is a block diagram of a system 200 for creating a synthesized test data having a predefined test case coverage, in accordance with an embodiment of the present disclosure. As shown, the system comprises at least one processor (depicted as a processor 202). The at least one processor 202 is configured to process a query for extracting a plurality of test cases and for determining a data storage location of input test data corresponding to the plurality of test cases. Moreover, the at least one processor is configured to extract the input test data from a data repository 204 and execute the plurality of test cases on an input test data and determining individual test case coverage percentages of the input test data. Optionally, the system 200 further comprises the data repository 204. Furthermore, the at least one processor 202 is configured to determine an overall test case coverage of the input test data, based on the individual test case coverage percentages of the input test data. Furthermore, when the overall test case coverage of the input test data is less than the predefined test case coverage, the at least one processor 202 is further configured to identify one or more test cases amongst the plurality of test cases for which individual test case coverage percentage of the input test data is less than a predefined value. Furthermore, the at least one processor 202 is further configured to analyze a distribution of the input test data, with respect to conditions in the one or more test cases. Furthermore, the at least one processor 202 is further configured to rebalance the input test data based on the distribution of the input test data, for producing the synthesized test data, wherein the input test data is rebalanced to cover the conditions in the one or more test cases in a manner that an overall test case coverage of the synthesized test data would be equal to or greater than the predefined test case coverage.

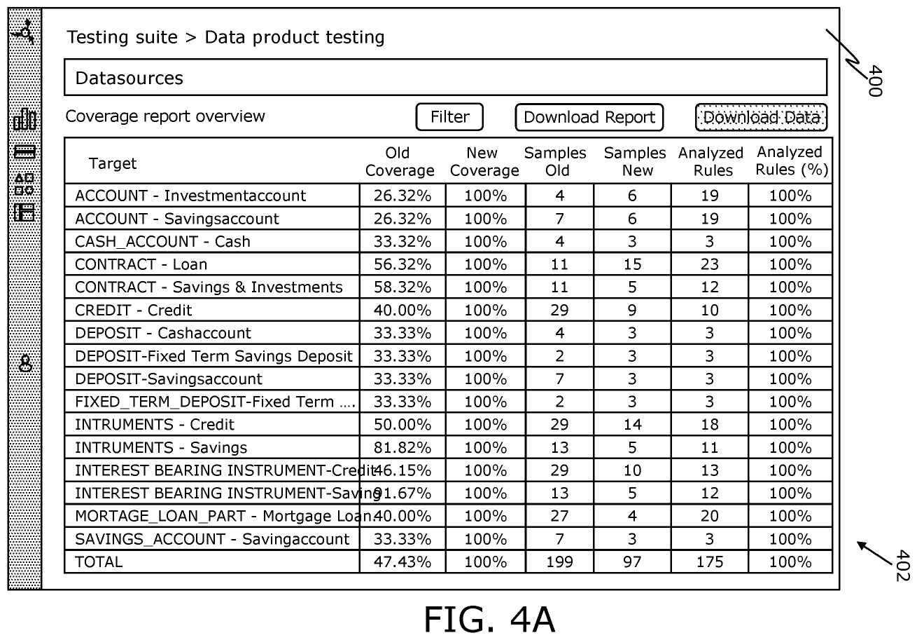

Referring to FIG. 3, illustrated is a schematic illustration of an implementation scenario of a system 300 for creating a synthesized test data 302 having a predefined test case coverage, in accordance with an embodiment of the present disclosure. As shown, a tester 304 executes a plurality of test cases using an input test data on an application 306 to determine individual test case coverage percentages, wherein the application 306 is communicably coupled to a data repository 310 to extract the input test data. Moreover, an overall test case coverage 308 of the input test data is determined, based on the individual test case coverage percentages. Furthermore, when the overall test case coverage of the input test data is less than the predefined test case coverage, one or more test cases 312 are identified amongst the plurality of test cases for which individual test case coverage percentage of the input test data is less than a predefined value. Furthermore, the input test data is rebalanced based on the distribution of the input test data, for producing the synthesized test data 302, wherein the input test data is rebalanced for covering the conditions in the one or more test cases in a manner that an overall test case coverage of the synthesized test data would be equal to or greater than the predefined test case coverage. Furthermore, the synthesized test data 302 is stored in the data repository 310. Furthermore, a test case coverage report 314 is generated based on the overall test case coverage of the synthesized test data.

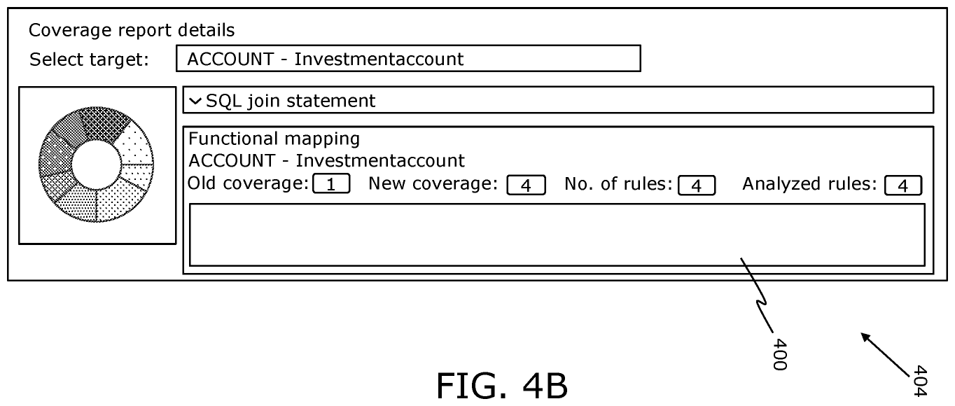

Referring to FIGS. 4A and 4B, illustrated are schematic illustrations of different views of a user interface depicting a test case coverage report 400, in accordance with an embodiment of the present disclosure. As shown in a first view 402 of the user interface, in an example, for an individual test case “ACCOUNT-Investmentaccount”, “Old coverage (%)” is shown to be “26.32%”, “New coverage (%)” is shown to be “100%”, “Sample old” is shown to be “4”, “Sample new” is shown to be “6”, “Analyzed rules” is shown to be “19”, and “Analyzed rules (%)” is shown to be “100”. In another example, for another individual test case “CREDIT-Credit”, “Old coverage (%)” is shown to be “40%”, “New coverage (%)” is shown to be “100%”, “Sample old” is shown to be “29”, “Sample new” is shown to be “9”, “Analyzed rules” is shown to be “10”, and “Analyzed rules (%)” is shown to be “100”. As shown in a second view 404 of the user interface, in an example, a “Selected target” is shown to be “ACCOUNT-Investmentaccount”, “Old coverage” is shown to be “1”, “New coverage” is shown to be “4”, “New rules” is shown to be “10”, “Analyzed rules” is shown to be “4”, and a pie chart depicting “Total rules” is shown.

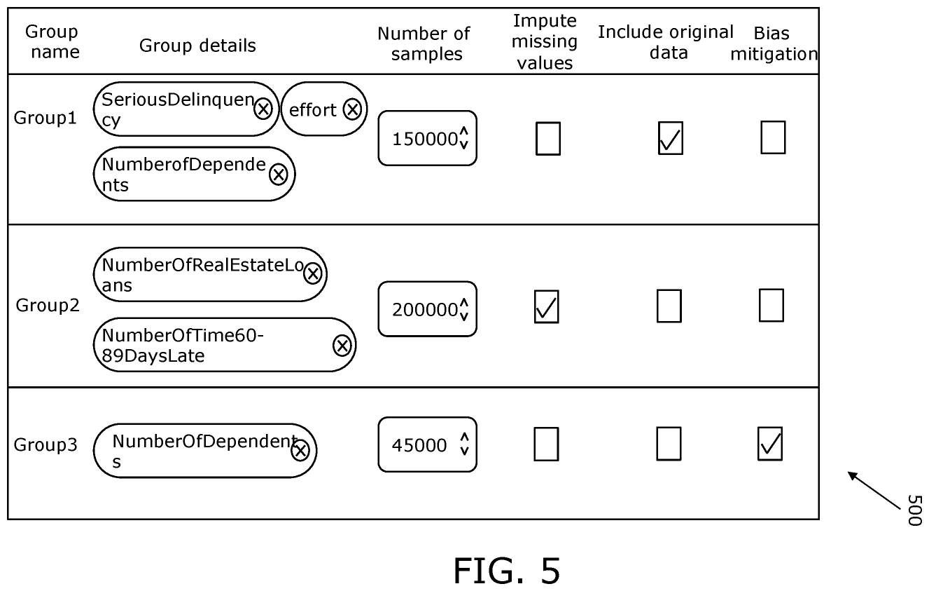

Referring to FIG. 5, illustrated is a user interface 500 depicting how rebalancing an input test data is performed, in accordance with an embodiment of the present disclosure. As shown, in an example, “Group 1” is shown to have “Group details” as “SeriousDeliquency”, “effort”, “NumberOfDependents”, “Number of samples” as “150000”, “Impute missing values” as unchecked, “Include original data” as checked, and “Blas mitigation” as unchecked.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-15. (canceled)

16. A method for creating a synthesized test data having a predefined test case coverage, the method comprising:
processing a query for extracting a plurality of test cases and for determining a data storage location of input test data corresponding to the plurality of test cases;
extracting the input test data from a data repository and executing the plurality of test cases on the input test data for determining individual test case coverage percentages of the input test data;
determining an overall test case coverage of the input test data, based on the individual test case coverage percentages of the input test data;
when the overall test case coverage of the input test data is less than the predefined test case coverage, identifying one or more test cases amongst the plurality of test cases for which individual test case coverage percentage of the input test data is less than a predefined value;
analyzing a distribution of the input test data, with respect to conditions in the one or more test cases; and
rebalancing the input test data based on the distribution of the input test data, for producing the synthesized test data, wherein the input test data is rebalanced for covering the conditions in the one or more test cases in a manner that an overall test case coverage of the synthesized test data would be equal to or greater than the predefined test case coverage.

17. The method according to claim 16, wherein the predefined test case coverage lies in a range of 80 percent to 99.9 percent, and wherein the predefined value lies in a range of 60 percent to 99.9 percent.

18. The method according to claim 16, wherein the step of rebalancing the input test data comprises at least one of:
altering a portion of the input test data;
adding new test data to the input test data;
adjusting the distribution of the input test data across different conditions in the plurality of test cases;
validating the input test data; and
removing redundancy in the input test data.

19. The method according to claim 16, further comprising at least one of:
creating the plurality of test cases; and
accessing a record of pre-created test cases that is stored at the data repository.

20. The method according to claim 16, further comprising generating a test case coverage report indicative of at least one of: the individual test case coverage percentages, the overall test case coverage, the one or more test cases a portion of the input test data which covers a given test case, a portion of the query which indicates a given test case, a coverage status of each condition of a given test case.

21. The method according to claim 16, wherein the input test data has same schema, data type and statistical properties as a production data and is one of: the production data, an obfuscated subset of the production data, mock data.

22. The method according to claim 16, further comprising removing sensitive data from the input test data.

23. The method according to claim 16, further comprising storing the synthesized test data at the data repository.

24. A system for creating a synthesized test data having a predefined test case coverage, the system comprising at least one processor configured to:
process a query for extracting a plurality of test cases and for determining a data storage location of input test data corresponding to the plurality of test cases;
extract the input test data from a data repository and execute the plurality of test cases on an input test data and determining individual test case coverage percentages of the input test data;
determine an overall test case coverage of the input test data, based on the individual test case coverage percentages of the input test data;
when the overall test case coverage of the input test data is less than the predefined test case coverage, identify one or more test cases amongst the plurality of test cases for which individual test case coverage percentage of the input test data is less than a predefined value;
analyze a distribution of the input test data, with respect to conditions in the one or more test cases; and
rebalance the input test data based on the distribution of the input test data, for producing the synthesized test data, wherein the input test data is rebalanced to cover the conditions in the one or more test cases in a manner that an overall test case coverage of the synthesized test data would be equal to or greater than the predefined test case coverage.

25. The system according to claim 24, wherein the predefined test case coverage lies in a range of 80 percent to 99.9 percent, and wherein the second predefined value lies in a range of 60 percent to 99.9 percent.

26. The system according to claim 24, wherein when rebalancing the input test data, the at least one processor is configured to perform at least one of:
alter a portion of the input test data;
add new test data to the input test data;
adjust the distribution of the input test data across different conditions in the plurality of test cases;
validate the input test data; and
remove redundancy in the input test data.

27. The system according to claim 24, wherein the at least one processor is further configured to perform at least one of:
create the plurality of test cases; and
access a record of pre-created test cases that is stored at the data repository, wherein the data repository is communicably coupled to the processor.

28. The system according to claim 24, wherein the at least one processor is further configured to generate a test case coverage report indicative of at least one of: the individual test case coverage percentages, the overall test case coverage, the one or more test cases, a portion of the input test data which covers a given test case, a portion of the query which indicates a given test case, a coverage status of each condition of a given test case.

29. The system according to claim 24, wherein the input test data has same schema, data type and statistical properties as a production data and is one of: the production data, an obfuscated subset of the production data, mock data.

30. The system according to claim 24, wherein the at least one processor is further configured to remove sensitive data from the input test data.
